(19) United States
(12) Patent Application Publication
(10) Pub. No.: US 2021/0327163 A1
(43) Pub. Date: Oct. 21, 2021

(54) ROUTER FOR VEHICLE DIAGNOSTIC SYSTEM

(71) Applicant: Innova Electronics Corporation, Irvine, CA (US)

(72) Inventors: Bruce Brunda, Irvine, CA (US); David Rich, Irvine, CA (US)

(21) Appl. No.: 16/853,538

(22) Filed: Apr. 20, 2020

(51) Int. Cl. G07C 5/00; G07C 5/08

(52) U.S. Cl. CPC G07C 5/008; G07C 2205/02; G07C 5/0808

(57) ABSTRACT

A vehicle diagnostic system includes a first diagnostic server including a diagnostic database having historical data matched with possible vehicle fixes, and configured to receive retrieved vehicle data and identify a most likely vehicle fix associated therewith. The first diagnostic server is associated with a first processing capability. The system additionally includes a second diagnostic server including a diagnostic algorithm operatively associated therewith and configured to identify a possible vehicle fix based on an assessment of the retrieved diagnostic data according to predefined criteria associated with the diagnostic algorithm. The second diagnostic server is associated with a second processing capability. A diagnostic router is disposable in communication with the first and second diagnostic servers and is configured to determine which one of the first and second diagnostic servers to send retrieved diagnostic data based on an assessment of the retrieved data and the first and second processing capabilities.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to a router for routing vehicle data, and more specifically, to a router capable of routing vehicle data based on an assessment of available resources and a desired functionality associated with the vehicle data.

### 2. Description of the Related Art

Over the years, vehicles have evolved into sophisticated electromechanical machines, that incorporate electrical sensors and computers into the overall mechanical framework of the vehicle. During operation of the vehicle, the electrical components and systems on the vehicle may generate data representative of the operation and health of the vehicle. The onboard systems may monitor the generated data and when the data reveals operation of a particular component or system outside of an acceptable operable range, a fault code may be generated and stored locally on the vehicle.

Data stored on the vehicle may be retrieved by a mechanic or owner of the vehicle to conduct a diagnosis of the vehicle. For instance, a scan tool may be connected into a diagnostic port on the vehicle to retrieve the data from an onboard computer. The data retrieved from the vehicle may include diagnostic codes, as well as the underlying live data which triggered the code(s), or otherwise relates to the code(s). Sensor data, freeze frame data, operational data, may also be retrieved from the vehicle for diagnostic purposes. In this regard, the retrieval and analysis of data may be analogous to a blood test for the vehicle. The data may be analyzed based on a comparison with historical information, by use of a diagnostic algorithm or by use of other diagnostic techniques. Implementation of the preferred vehicle diagnostic methodology may require the transfer of data from the vehicle to whatever resource is being used to analyze the data, such as a remote diagnostic database.

In addition to automotive diagnostics, data transfer from the vehicle has also been critical to the development of autonomous or driverless vehicles, which may be capable of sensing its environment and navigating without human input. Autonomous cars use a variety of techniques to detect their surroundings, such as radar, laser light, GPS, odometry, and computer vision. Advanced control systems interpret sensory information to identify appropriate navigation paths, as well as obstacles and relevant signage. Autonomous cars have control systems that are capable of analyzing sensory data to distinguish between different cars on the road, which is very useful in planning a path to the desired destination.

Individual autonomous vehicles may benefit from information obtained from not only their own information system, but also from information systems operating on other vehicles in the vicinity, which may be useful as a way to communicate information relating to upcoming traffic congestion and safety hazards. As such, vehicular communication systems may use other vehicles and roadside units as the communicating nodes in a peer-to-peer network, providing each other with information. By using such a cooperative approach, vehicular communication systems can allow all cooperating vehicles to be more effective. According to a 2010 study by the National Highway Traffic Safety Administration, vehicular communication systems could help avoid up to 79 percent of all traffic accidents.

The communications systems to implement the connected vehicle applications include vehicle-to vehicle (V2V) and vehicle-to-infrastructure (V2I) applications that require a minimum of one entity to send information to another entity. Broadly, short range communications that occur between a vehicle and any similarly equipped external object may be collectively referred to as “V2X” communications. For example, many vehicle-to-vehicle safety applications can be executed on one vehicle by simply receiving broadcast messages from one or more neighboring vehicles. These messages are not necessarily directed to any specific vehicle, but are meant to be shared with a vehicle population to support the safety application. In these types of applications where collision avoidance is desirable, as two or more vehicles talk to one another in a setting where a collision becomes probable, the vehicle systems can warn the vehicle drivers, or possibly take action for the driver, such as applying the brakes. Likewise, roadway infrastructure components, such as traffic control units, can observe the information broadcasts or otherwise sense vehicle traffic and provide a driver warning if there is a detected hazard (e.g., if a vehicle is approaching a curve at an unsafe speed or there is a crossing vehicle that is violating a red traffic signal phase).

It would also be useful to interface vehicle diagnostic resources to the V2X data stream, to allow vehicle defects, diagnostic solutions and related information to be identified and addressed, even where the vehicle is not itself associated with any diagnostic processing resources.

In view of the widespread use of vehicle data, there is a need in the art for a system and method of efficiently routing the information, including vehicle diagnostic information, based on any number of a variety of different factors, such as resource availability, intended functionality, latencies associated with different resources, urgency, etc. Various aspects of the present disclosure address this particular need, as will be discussed in more detail below.

### BRIEF SUMMARY

Various aspects of the present disclosure are related to systems and methods of routing vehicle data to efficiently and quickly process the data and implement desired functionalities. Data may be received from a vehicle and may be used from a variety of different resources (e.g., a diagnostic database, a diagnostic algorithm, a V2X data stream, etc.) for a variety of different purposes (e.g., determining a most likely fix, alerting nearby drivers of a critical condition, etc.). The determination of which resources are used and which functionalities are executed may be determined by a variety of different factors, such as the processing ability of each resource, processing latency, diagnostic urgency, or preprogrammed conditions.

In accordance with one embodiment of the present disclosure there is provided a vehicle diagnostic system comprising a vehicle data acquisition and transfer device connectable to a diagnostic port on a vehicle to retrieve vehicle data therefrom. The vehicle data includes, but is not limited to, vehicle identification information and vehicle diagnostic data. The system may include a first diagnostic server disposable in communication with the vehicle data acquisition and transfer device, and including a diagnostic database having the ability to match historical data with possible/most likely vehicle fixes. The first diagnostic server may be configured to receive the retrieved vehicle data and identify a most likely vehicle fix associated with the retrieved vehicle data. The first diagnostic server may be associated with a first processing capability.

The system may additionally include a second diagnostic server having a diagnostic algorithm loaded thereon and operatively associated therewith and configured to identify a possible vehicle fix based on an assessment of the retrieved diagnostic data according to predefined criteria associated with the diagnostic algorithm. The second diagnostic server may be associated with a second processing capability.

The system may additionally include a diagnostic router disposable in communication with the vehicle data acquisition and transfer device and with the first and/or second diagnostic servers. The diagnostic router may be configured to determine which one of the first and second diagnostic servers to send the retrieved diagnostic data, based on an assessment of the retrieved data and the first and second processing capabilities.

The data acquisition and transfer (DAT) device may be implemented as a dongle or a scan tool. The first and second diagnostic servers may be located remote from the DAT device. The diagnostic router may, for example, be disposed intermediate the diagnostic port and a scan tool. The diagnostic router may alternatively be disposed intermediate the diagnostic port and the first diagnostic server. The diagnostic router may be implemented on the DAT device, or an associated programmable cellphone or other communication device. The second diagnostic server may be located on the DAT device, and the first diagnostic server may be remote from the scan tool.

The first processing capability may encompass a first latency period associated with processing at least a portion of the received vehicle data at the first diagnostic server. The second processing capability may encompass a second latency period associated with processing at least a portion of the received vehicle data at the second diagnostic server. The diagnostic router may be operative to compare the first latency period with the second latency period. As will be apparent to one of ordinary skill in the art, the respective latency periods and other processing characteristics/abilities may vary depending upon the nature of the received vehicle data, and the desired processing functionality.

The first processing capability may encompass processing vehicle data stored in the diagnostic database, and the second processing capability may encompass processing vehicle data using the diagnostic algorithm.

According to another embodiment of the present disclosure, there is provided a vehicle diagnostic method including receiving vehicle data from a vehicle computer at a diagnostic router, with the vehicle data including vehicle diagnostic data and vehicle identification information. The method additionally includes deriving first processing capability information associated with a first diagnostic server, with the first diagnostic server having historical data matched with possible vehicle fixes. The first diagnostic server is preferably configured to receive retrieved vehicle data and identify a possible vehicle fix associated with the retrieved vehicle data. The method further comprises deriving second processing capability information associated with a second diagnostic server, with the second diagnostic server including a diagnostic algorithm operatively associated therewith and configured to identify a possible vehicle fix based on an assessment of the retrieved vehicle diagnostic data according to predefined criteria associated with the diagnostic algorithm. The method additionally includes comparing the first processing capability information with the second processing capability information to determine which one of the first and second diagnostic servers to send the retrieved diagnostic data, or portions thereof.

The method may include receiving the possible vehicle fix from the first diagnostic server or the second diagnostic server at a handheld communication device.

The method may also include communicating the possible vehicle fix identified by the first diagnostic server or the second diagnostic server to a V2X infrastructure.

The vehicle data received at the diagnostic router may be received from a diagnostic scan tool or from a V2X infrastructure.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a vehicle diagnostic system including several diagnostic routers for routing data based on resource availability and desired functionality;

FIG. 2 is a graphical depiction of different resources and functions available to a router for routing vehicle data;

FIG. 3 is a flow chart associated with a vehicle diagnostic method associated with the present disclosure; and

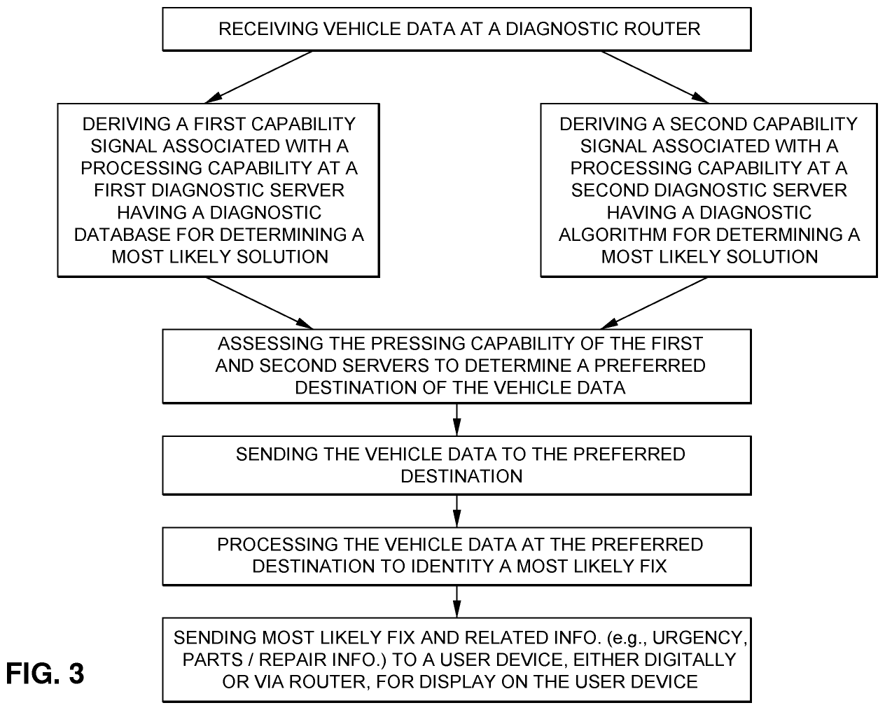

FIG. 4 is a flow chart associated with another embodiment of a vehicle diagnostic method associated with the present disclosure.

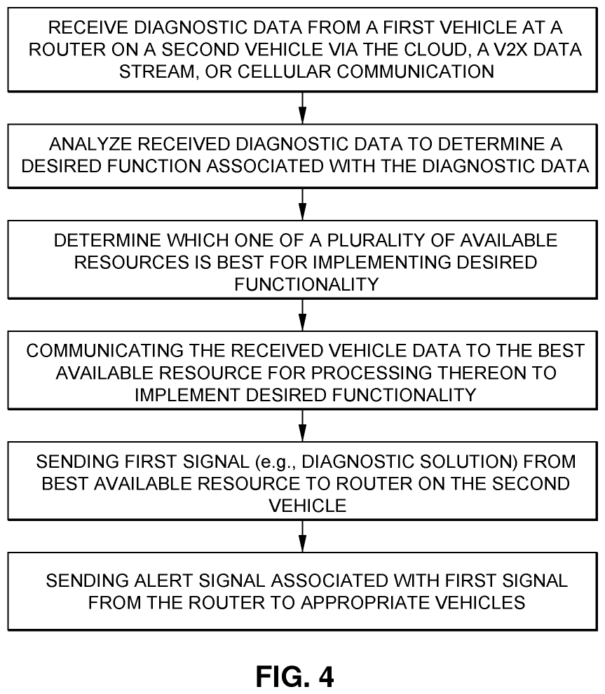

Common reference numerals are used throughout the drawings and the detailed description to indicate the same elements.

### DETAILED DESCRIPTION

The detailed description set forth below in connection with the appended drawings is intended as a description of certain embodiments of a data router in a vehicle communication system, and related methodologies, and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

Various aspects of the present disclosure relate to the routing of vehicle data to one or more resources or destination based on one or more factors, such as desired functionality, processing latency, resource availability and capability, and operational urgency or diagnostic urgency. One embodiment may include a diagnostic router deployed within a vehicle diagnostic system for determining where vehicle data or related information should be communicated. For instance, the vehicle data may be communicated to a diagnostic database or a diagnostic algorithm for diagnostic analysis. It is also contemplated that the vehicle data may indicate an urgent problem with the vehicle, and thus, an alert signal may be routed to the driver, as well as to a V2X infrastructure to alert nearby drivers of the urgent condition. Thus, the router may allow for a more efficient implementation of desired diagnostic functionality by relying on a comprehensive network of resources and their known capabilities.

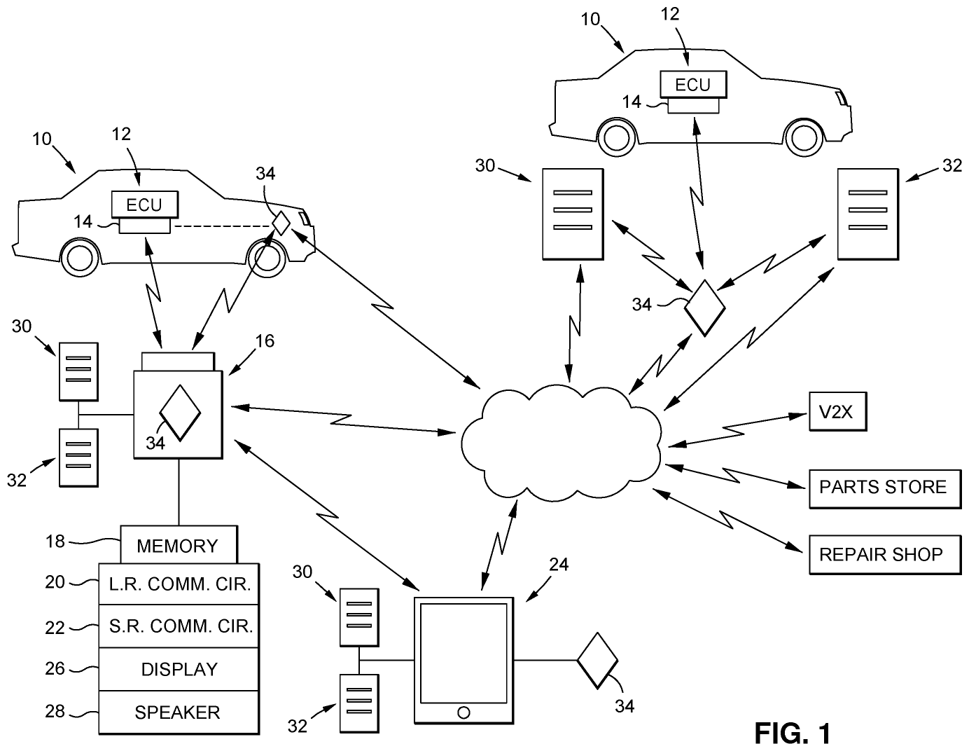

Referring now specifically to FIG. 1, there is depicted a vehicle 10 having an electronic control unit (ECU) 12, which includes one or more onboard computers in communication with one or more sensors or systems on the vehicle 10. The vehicle 10 may produce vehicle data during operation of the vehicle 10. The vehicle data may include diagnostic trouble codes (DTCs), live data, freeze frame data, parameter id (PID) data, sensor data, etc. The vehicle data may be stored on the ECU 12 and accessed through a diagnostic port 14 located on the vehicle 10. The ECU 12 may also have vehicle identification information, such as an electronic vehicle identification number, or information related to the year, make, model, and engine, stored thereon and available for retrieval.

A vehicle data acquisition and transfer (DAT) device 16 is connectable to the diagnostic port 14 on the vehicle 10 to retrieve vehicle data therefrom. The device 16 may include a scan tool, a dongle or other hardware capable of communicating with the ECU 12. The device 16 may be plug connectable to the diagnostic port 14 to place the device 16 in wired communication with the ECU 12 to facilitate data transfer therebetween. Alternatively, the device 16 and the ECU 12 may both be configured to facilitate wireless communication between the ECU 12 and the device 16. Such hardware may be located on the vehicle 10, in the vehicle 10, or outside of the vehicle 10, e.g., in the case of a V2X system.

The device 16 may include an internal memory 18 for storing preprogrammed operating instructions thereon, as well as for storing data received by the device 16, such as vehicle data or alerts, as will be described in more detail below. The device 16 may also include a long-range communication circuit 20 for facilitating bi-directional wireless communication over a communication network, such as a cellular communication network, cloud-based communications, or communications over the Internet. The device 16 may also include a short-range communication circuit 22 for facilitating bi-directional wireless communication with a nearby electronic device, such as with a smartphone 24 via Bluetooth™, or other short-range communication protocols. The device 16 may include a display screen 26 for displaying information or providing visual alerts to a user. The device 16 may also include a speaker 28 for communicating audible alerts to a user.

As noted above, the device 16 may be disposable in communication with a smartphone 24 or other handheld communication device (e.g., tablet computer, smart watch, etc.). The smartphone 24 may be used as a communication relay between the device 16 and a remote destination. The smartphone 24 may also be used to display retrieved vehicle data or information related thereto. The smartphone 24 may have operating instructions, such as an application (“app.”) that facilitates processing of vehicle data.

FIG. 1 additionally includes a first diagnostic server 30 and a second diagnostic server 32. The first diagnostic server 30 may include a database of historical data matched with possible vehicle fixes. Accordingly, when vehicle data is retrieved from a vehicle 10, the first diagnostic server 30 may be configured to receive the retrieved vehicle data and identify a most likely vehicle fix associated with the retrieved vehicle data. The analysis of the vehicle data may be vehicle specific, such that the vehicle identification information of the vehicle under test is used to identify vehicle data stored in the database and associated with similar or identical vehicle identification information. The solution associated with vehicle data most closely corresponding to the retrieved vehicle data, and which may be associated with vehicle identification information similar to the vehicle under test may be considered the most likely fix. Once the most likely fix is identified, the first diagnostic server 30 may send a signal to the user via the smartphone 24 or scan tool 16, with the signal identifying the most likely fix. For more information related to one process for analyzing vehicle data and the use of a diagnostic database to determine a most likely fix, please refer to U.S. Pat. No. 8,370,018 entitled Automotive Diagnostic Process, and U.S. Pat. No. 9,646,432 entitled Hand Held Data Retrieval Device with Fixed Solutions Capability, the contents of both of which are expressly incorporated herein by reference.

The first diagnostic server 30 may also be capable of performing predictive diagnostics, wherein the vehicle identification data is analyzed along with the current mileage of the vehicle, and compared to historical data stored in the database including the mileage when faults occurred to predict future diagnostic events for the vehicle under test. For more information related to predictive diagnostics, please refer to U.S. Patent Application Publication No. 2016/0027223, entitled Predictive Diagnostic Method, the contents of which are expressly incorporated herein by reference.

The first diagnostic server 30 is also associated with a first processing capability, which may relate to a variety of different factors. The first processing capability may refer to a latency period (e.g., a first latency period) associated with processing vehicle data to determine a most likely fix. The first latency period may be dependent upon the speed of the communication links which supply the vehicle data to the first diagnostic server, the speed of processing data at the first diagnostic server, and the speed of the communication links along which information is transmitted from the first diagnostic server. In this regard, the first latency period may refer to the time that elapses from the time a request is made, such as a request for a most likely fix, and the time the answer to the request is delivered to the final destination, e.g., the receipt of the most likely fix.

The first processing capability may also refer to the presence and maturity of the data on the first diagnostic server 30. Along these lines, the first diagnostic server 30 may not include a large amount of historical data stored for newer vehicles. In some cases, there may be no data for new vehicles, in which case the first server may be incapable of reliably satisfying a request for a most likely fix.

Given that several different variables may factor into the first processing capability, it is contemplated that the first processing capability may be determined by a predefined formula that assigns weights to the various factors. The formula may produce an overall score (e.g., number), which is representative of the first processing capability.

The second diagnostic server 32 may include a diagnostic algorithm which may be stored thereon and configured to identify a possible vehicle fix based on an assessment of the retrieved diagnostic data according to predefined criteria associated with the diagnostic algorithm. A diagnostic assessment using the algorithm may differ from a diagnostic assessment using the historical database in that the algorithm may not require a comparison of retrieved vehicle data with historical data. Rather, the retrieved vehicle identification and diagnostic data may be all that is needed, with the retrieved vehicle data being entered into the algorithm to determine the most likely fix. Since historical data may not be required when conducting an analysis using with algorithm, there may be advantages with the algorithm, as less data may be involved in the analysis, which may result in faster processing speeds. The diagnostic algorithm may be routinely updated or revised based on feedback from users in the field regarding both positive and negative results of the algorithm.

The second diagnostic server 32 may be also associated with a second processing capability, which may relate to a variety of different factors. The second processing capability may refer to the functional limitations of the algorithm and the latency period (e.g., a second latency period) associated with processing vehicle data to determine a most likely fix. The second latency period may be dependent upon the speed of the communication links which supply the vehicle data to the second diagnostic server 32, the speed of processing data at the second diagnostic server 32, and the speed of the communication links along which information is transmitted from the second diagnostic server 32. In this regard, the second latency period may refer to the time that elapses from the time a request is made, such as a request for a most likely fix, and the time the answer to the request is delivered to the final destination, e.g., the receipt of the most likely fix, based on the applicable pathways, e.g., via a cellular system, Internet, and/or V2X pathways.

As shown in FIG. 1, the first and second diagnostic servers 30, 32, or portions thereof, may be located in a variety of different locations. For instance, the first and second diagnostic servers 30, 32 may be remote from the vehicle, the scan tool 16, and the smartphone 24. It is also contemplated that one or both of the first and second diagnostic servers 30, 32 may be located on the scan tool 16, or on the smartphone 24. It is understood that the storage space and processing capability may be limited on the scan tool 16 and the smartphone 24, and thus, it may not be feasible to include the entireties of the first and second servers on the scan tool 16 and smartphone 24. However, in the case of the algorithm associated with the second server, it may be more feasible to store and operate the algorithm on the scan tool 16 and/or the smartphone 24. With regard to the diagnostic database, it is contemplated that select portions thereof may be downloaded onto the scan tool 16 and/or smartphone 24 to allow for diagnostic analysis using the database locally on the scan tool 16 or smartphone 24. For instance, the most likely solutions that are most commonly associated with the vehicle under test, and the underlying historical data, may be downloaded onto the scan tool 16 and or the smartphone 24, or configured for a particular vehicle from data loaded on the scan tool, as truncated versions of the first server.

The system shown in FIG. 1 also includes a plurality of routers 34 which are operative to route communications between the various sources of data and destinations of the data and the related signals, based on a variety of different factors. In this regard, the routers 34 may be in communication with the ECU, the scan tool 16, the smartphone 24, the first server, and the second server to facilitate communications within the system of FIG. 1. The decisions made by the router 34 as to a given destination may be determined by one or more factors including, but not limited to, the number of available resources, the capability of the available resources, the processing speed of the available resources, an urgency associated with the vehicle data, and a desired functionality. The router 34 may be implemented on a remote computer accessible via the cloud, or alternatively, the router 34 may be stored on the scan tool 16, the smartphone 24, or on the vehicle. In this case of the router 34 being stored on the vehicle 10, it is contemplated that the router may be integrated into the vehicle ECU 12, or alternatively, the router 34 may be integrated into structure commonly associated with a vehicle, such as a vehicle license plate frame, and which may have communication capabilities, such as to communication with a V2X infrastructure. For more information regarding such structures, please refer to U.S. Patent Application Publication No. 2020/0092694 entitled Method and System for Communicating Vehicle Position Information to an Intelligent Transportation System, the contents of which are expressly incorporated herein by reference.

Each router 34 may include the necessary hardware and software for deciding when and where to send data, alerts or signals. In this regard, the router 34 may include a communication circuit for sending and receiving data, alerts or signals, as well as a data processing circuit for processing data or other information needed to implement the functionality of the router.

In one embodiment, the router 34 may be configured to receive a data packet, analyze the data packet to identify a functionality associated with the data packet, and then identify available resources and their associated processing capabilities e.g., VIN decoders, parts/services resources, etc. In this regard, the router 34 may be configured to routinely monitor available resources and their associated capabilities. The router 34 may be able to identify more permanent resources, such as those available through the cloud, as well as resources that may be more temporary, such as a resource available in a nearby vehicle, which may be expected to move out of range after a short period of time. By routinely monitoring the available resources, the router 34 may be able to more quickly route data and information upon receiving a data packet.

As an alternative, the router 34 may obtain available resource information after the data packet is received. Accordingly, the router 34 may not routinely monitor available resources, as such routing monitoring may require processing capability on the router that may not be available, e.g., the router 34 may require most, if not all, processing capability for sending and receiving data.

The processing capabilities on the router 34 may allow for the router 34 to identify one or more conditions associated with the received data and execute one or more preprogrammed functions associated with the detected condition. For instance, if the received vehicle data reveals an underlying urgent condition, the router 34 may push out an alert to all nearby receivers. The ability to identify certain conditions may require a memory on the router, which allows for storage of the conditions on the router 34. In this regard, the router 34 may be capable of scanning the received data to see if any portion of the data matches any of the preprogrammed conditions. If a match is detected, the router 34 may execute a stored function associated with the condition.

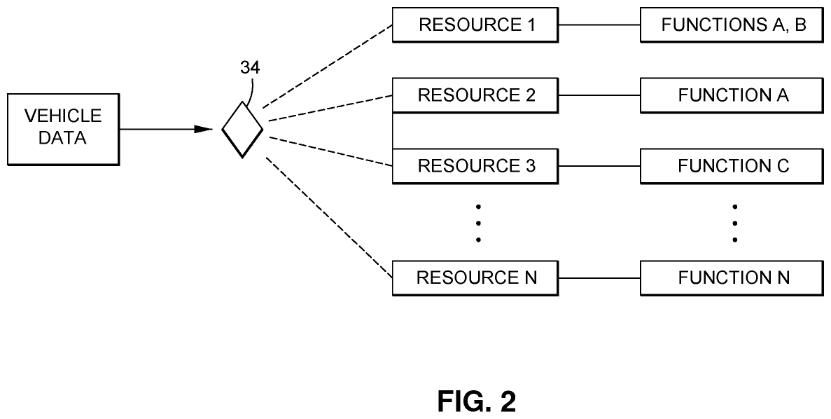

Referring now to FIG. 2, there is provided an exemplary illustration of how a router 34 may route vehicle data based on available resources and desired functions. In FIG. 2, Resources 1-N are provided and Functions A-N are identified. Resource 1 is capable of performing Functions A and B, while Resource 2 is capable of only performing Function A. Resource 3 is capable of performing Function C. Thus, when the vehicle data comes into the router, a desired function may also be associated with the vehicle data. The desired function may be selected by a user, or a preprogrammed function. If the preprogrammed function is Function A, then the router 34 may identify Resources 1 and 2 as possible resources for implementing the function, while eliminating the remaining resources as possibilities. Next, the router 34 compares the processing capabilities of Resources 1 and 2, and identifies which resource is associated with the most favorable processing capability. The router 34 then sends the vehicle data to the identified resource for execution of Function A.

If the function associated with the received vehicle data is Function B or Function C, the router 34 may identify that each function is only associated with one resource. Thus, the router 34 would send the vehicle data to the sole available resource, e.g., Resource 1 for Function B and Resource 3 for Function C.

The routing of data, the processing of any vehicle data or information, and/or the generation of any signals, alerts or displays in response to processing the vehicle data may be done autonomously and with minimal or no input by a user (e.g., independent of a user). Rather, the functionalities described herein may be governed by operational instructions (e.g., computer programming) implemented by the various components in the system. For more information regarding autonomous operation of vehicle diagnostics, please refer to U.S. Pat. No. 9,824,507, entitled Mobile Device Based Vehicle Diagnostic System, the contents of which are expressly incorporated herein by reference.

The following examples illustrate variations uses of the router.

### Example 1—Determining Database or Algorithm for Diagnostic Analysis

As described above, a diagnostic assessment of data retrieved from the vehicle may include analysis of the vehicle data at the first server or the second server to identify a most likely fix. The determination of whether to use the first server or the second server may include a comparison of the first processing capability and the second processing capability. The more favorable of the first and second processing capabilities may be identified by the router 34 and the vehicle data may be transmitted to the corresponding server.

For instance, if the first and second servers are both capable of analyzing the data, but the first server has a higher latency period that the second server, then the router 34 may send the vehicle data to the second server to obtain a quicker answer. As another example, if the algorithm has not been formulated to handle vehicle data from the vehicle under test, the router 34 may send the vehicle data to the first server.

### Example 2—Distributing a V2X Alert

A V2X infrastructure allows vehicles to communicate with each other. Oftentimes, communications over a V2X network allow for collision avoidance, and for more efficient routing of a vehicle to its destination.

It is contemplated that the router 34 described herein by be used to send and receive communication signals to and from a V2X infrastructure to enhance the safety and efficiency of vehicles associated with the V2X infrastructure.

For instance, if it is determined, based on an analysis of vehicle data, that a particular vehicle is likely to be experiencing a potentially critical diagnostic issue, an alert may be communicated to vehicles within a given proximity to the problematic vehicle to make those adjacent drivers, or adjacent navigation systems more aware of the problematic vehicle. In view of the alert, the adjacent drivers or navigation systems may adopt a more defensive posture around the problematic vehicle. By processing the alert, the system may confirm the urgency, or may determine that the condition is not urgent, for the particular vehicle on which the condition exists.

The alert may be generated at the resource that identifies the critical condition. For instance, the alert may be generated at the first and second servers, which may be have a list of most likely fixes that are critical, such that if one of those most likely fixes is identified, the server may generate the alert signal, which may be sent to the router. When the router 34 receives the alert signal, the router may push the alert signal out to all nearby receivers in the network. In this regard, the alert may be received by adjacent vehicles, adjacent smartphones 24, adjacent scan tools 16, adjacent pedestrian control signals, adjacent traffic control signals, etc., which may take appropriate action when receiving the alert. The router may cease normal communications until the alert signal has been relayed to the appropriate destinations.

### Example 3—Managing Communications Based on Urgency

Similar to the alert discussed above, it is contemplated that operation of the router 34 may be dictated by a diagnostic urgency associated with a most likely fix. For instance, certain diagnostic conditions may be associated with a low urgency (e.g., gas cap is loose), while other conditions may be associated with a high urgency (e.g., brake failure). For a more detailed discussion regarding determination of diagnostic urgency, please refer to U.S. Pat. No. 9,761,062 entitled A Method and Apparatus for Indicating an Automotive Diagnostic Urgency, the contents of which are expressly incorporated herein by reference.

When the vehicle data or the most likely fix is associated with a high urgency, the router 34 may execute preprogrammed actions to mitigate the urgent condition. For instance, the router 34 may send a signal to the vehicle associated with the highly urgent condition for display on the vehicle's console. It is also contemplated that the router 34 may send a signal to the scan tool 16 or the smartphone 24 for display thereon.

It is also contemplated that the router 34 may send an alert to other electronic addresses associated with the vehicle, such as the e-mail address or SMS address of another registered individual associated with the vehicle (e.g., to the parent of a teenage driver) to make them aware of the urgent condition. The router 34 may also send a message to a nearby repair shop to order any parts, schedule a repair, or request a bid for fixing the highly urgent condition.

### Example 4—Efficient Use of In-Network Resources

Another exemplary use of the router 34 may relate to its ability to identify nearby resources as being available for executing a desired function. For instance, a vehicle may have a scan tool 16 plugged into its diagnostic port and routinely scanning for vehicle data. When a problem arises, as evidenced in the diagnostic data (e.g., the presence of one or more DTCs), it may be desirable to upload the diagnostic data to one of the first or second servers. Although the resources locally available in the vehicle may not include the first or second servers, it is contemplated that one or more adjacent vehicles may have resources including one or both of the first and second servers. For instance, a scan tool 16 in an adjacent vehicle may include diagnostic algorithm. Thus, the router 34 may consider the processing capabilities of any nearby first and second server that is communicable with the router.

The use of resources in adjacent vehicles may be facilitated through a subscription network, wherein subscribers to the network share their resources to allow for more resource availability.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A vehicle diagnostic system comprising:
a vehicle data acquisition and transfer device connectable to a diagnostic port on a vehicle to retrieve vehicle data therefrom, the vehicle data including vehicle identification information and vehicle diagnostic data;
a first diagnostic server disposable in communication with the vehicle data acquisition and transfer device and including a diagnostic database having historical data matched with possible vehicle fixes, the first diagnostic server being configured to receive the retrieved vehicle data and identify a most likely vehicle fix associated with the retrieved vehicle data, the first diagnostic server being associated with a first processing capability;
a second diagnostic server including a diagnostic algorithm operatively associated therewith and configured to identify a possible vehicle fix based on an assessment of the retrieved diagnostic data according to predefined criteria associated with the diagnostic algorithm, the second diagnostic server being associated with a second processing capability; and
a diagnostic router in communication with the vehicle data acquisition and transfer device and disposable in communication with the first and second diagnostic servers, the diagnostic router being configured to determine which one of the first and second diagnostic servers to send the retrieved diagnostic data based on an assessment of the retrieved data and the first and second processing capabilities.

2. The vehicle diagnostic system recited in claim 1, wherein the data acquisition and transfer device comprises a scan tool.

3. The vehicle diagnostic system recited in claim 2, wherein the first and second diagnostic servers are located remote from the scan tool.

4. The vehicle diagnostic system as recited in claim 2, wherein the diagnostic router is disposed intermediate the diagnostic port and the scan tool.

5. The vehicle diagnostic system recited in claim 4, wherein the diagnostic router is disposed intermediate the diagnostic port and the first diagnostic server.

6. The vehicle diagnostic system recited in claim 2, wherein the diagnostic router is located on the scan tool.

7. The vehicle diagnostic system recited in claim 6, wherein the second diagnostic server is located on the scan tool, and the first diagnostic server is remote from the scan tool.

8. The vehicle diagnostic system recited in claim 6, wherein the first processing capability encompasses a first latency period associated with processing at least a portion of the vehicle data at the first diagnostic server, and the second processing capability encompasses a second latency period associated with processing at least a portion of the vehicle data at the second diagnostic server.

9. The vehicle diagnostic system recited in claim 8, wherein the diagnostic router is operative to compare the first latency period with the second latency period.

10. The vehicle diagnostic system recited in claim 1, wherein the first processing capability encompasses processing vehicle data stored in the diagnostic database, and the second processing capability encompasses processing vehicle data using the diagnostic algorithm.

11. The vehicle diagnostic system recited in claim 1, wherein the vehicle data acquisition and transfer device is configured to autonomously request vehicle data in response to being connected to the diagnostic port.

12. The vehicle diagnostic system recited in claim 1, wherein the router is configured to autonomously determine which one of the first and second diagnostic servers to send the retrieved diagnostic data in response to receipt of the retrieved vehicle data.

13. A vehicle diagnostic method comprising:
receiving vehicle data from a vehicle computer at a diagnostic router, the vehicle data including vehicle diagnostic data and vehicle identification information;
receiving first processing capability information associated with a first diagnostic server, the first diagnostic server having historical data matched with possible vehicle fixes, the first diagnostic server being configured to receive retrieved vehicle data and identify a possible vehicle fix associated with the retrieved vehicle data;
receiving second processing capability information associated with a second diagnostic server, the second diagnostic server including a diagnostic algorithm operatively associated therewith and configured to identify a possible vehicle fix based on an assessment of the retrieved vehicle diagnostic data according to predefined criteria associated with the diagnostic algorithm; and
comparing the first processing capability information with the second processing capability information to determine which one of the first and second diagnostic servers to send the retrieved diagnostic data.

14. The method recited in claim 13, further comprising the step of receiving the possible vehicle fix from the first diagnostic server or the second diagnostic server at a handheld communication device.

15. The method recited in claim 13, further comprising the step of communicating the possible vehicle fix identified by the first diagnostic server or the second diagnostic server to a V2X infrastructure.

16. The method recited in claim 13, wherein the first processing capability information encompasses a first latency period associated with processing at least a portion of the vehicle data at the first diagnostic server.

17. The method recited in claim 13, wherein the second processing capability information encompasses a second latency period associated with processing at least a portion of the vehicle data at the second diagnostic server.

18. The method recited in claim 13, wherein the first processing capability information is associated with the historical data stored in the first diagnostic server.

19. The method recited in claim 13, wherein the diagnostic algorithm is capable of assessing vehicle diagnostic data associated with predefined vehicle identification information, the second capability signal being associated with the predefined vehicle identification information.

20. The method recited in claim 13, wherein the vehicle data received at the diagnostic router is received from a diagnostic scan tool.

21. The method recited in claim 13, wherein the vehicle data received at the diagnostic router is received from a V2X infrastructure.

22. A vehicle diagnostic system usable with a vehicle data acquisition and transfer device connectable to a diagnostic port on a vehicle to retrieve vehicle data therefrom, the vehicle data including vehicle identification information and diagnostic data, the vehicle diagnostic system comprising:
a first diagnostic server disposable in communication with the vehicle data acquisition and transfer device and including a diagnostic database having historical data matched with most likely vehicle fixes, the first diagnostic server being configured to receive retrieved vehicle data and identify a possible vehicle fix associated with the retrieved vehicle data, the first diagnostic server being associated with a first processing capability;
a second diagnostic server including a diagnostic algorithm operatively associated therewith and configured to identify a possible vehicle fix based on an assessment of the retrieved diagnostic data according to predefined criteria associated with the diagnostic algorithm, the second diagnostic server being associated with a second processing capability; and
a diagnostic router disposable in communication with the vehicle data acquisition and transfer device and disposable in communication with the first and second diagnostic servers, the diagnostic router being configured to determine which one of the first and second diagnostic servers to send the retrieved diagnostic data based on an assessment of the first and second capabilities.

23. The vehicle diagnostic system recited in claim 22, wherein the first processing capability encompasses a first latency period associated with processing at least a portion of the vehicle data at the first diagnostic server, and the second processing capability encompasses a second latency period associated with processing at least a portion of the vehicle data at the second diagnostic server.

24. The vehicle diagnostic system recited in claim 23, wherein the diagnostic router is operative to compare the first latency period with the second latency period.

25. The vehicle diagnostic system recited in claim 22, wherein the diagnostic router is configured to determine which one of the first and second diagnostic servers to send the retrieved diagnostic data autonomously in response to receipt of the retrieved diagnostic data.

26. A vehicle diagnostic method comprising:
receiving, at a router, vehicle data associated with a first vehicle;
identifying, at the router, a diagnostic resource for processing the vehicle data to identify a most likely fix based on an assessment of the vehicle data, the identified diagnostic resource being located in a second vehicle;
sending the vehicle data to the identified diagnostic resource to determine the most likely fix;
receiving the determined most likely fix from the identified diagnostic resource; and
sending the most likely fix to an electronic device associated with the first vehicle.

27. The vehicle diagnostic method recited in claim 26, further comprising the steps of:
determining an urgency associated with the most likely fix as being one of a high urgency or a low urgency; and
generating an alert signal for communication to a remote electronic device when the urgency is determined to be the high urgency.

28. The vehicle diagnostic method recited in claim 26, wherein the identified diagnostic resource is located on a scan tool operatively connected to the second vehicle.

29. The vehicle diagnostic method recited in claim 26, wherein the identifying step proceeds autonomously in response to receiving the vehicle data at the router.
